(19) United States
(12) Patent Application Publication
(10) Pub. No.: US 2007/0090100 A1
(43) Pub. Date: Apr. 26, 2007

(54) Glass cutting method and apparatus therefor

(76) Inventors: Toshifumi Yonai, Kanagawa (JP); Toshio Inami, Kanagawa (JP); Hideaki Kusama, Kanagawa (JP); Naoyuki Kobayashi, Kanagawa (JP); Mitsuhiro Toyoda, Kanagawa (JP); Kenichi Omori, Kanagawa (JP)

Correspondence Address: WENDEROTH, LIND & PONACK, L.L.P., 2033 K STREET N. W., SUITE 800, WASHINGTON, DC, 20006-1021, US

(21) Appl. No.: 10/559,816

(22) PCT Filed: Apr. 22, 2005
(86) PCT No.: PCT/JP05/07701

§ 371 Date: Dec. 8, 2005

(30) Foreign Application Priority Data
Apr. 27, 2004 (JP) 2004-131087

(51) Int. Cl. B23K 26/38

(52) U.S. Cl. 219/121.69; 264/400

(57) ABSTRACT

In the case of forming a scribe line by irradiating a laser in an ultraviolet range in one stroke, the glass bending strength after glass is cut is about 50 MPa or less, and the glass is likely to be subjected to crack damage during use as liquid crystal panel glass or the like. In a glass cutting method in which a portion to be cut of glass 4 is irradiated with a pulse laser 2 in one stroke of relative movement to form a scribe line 7, and then the glass is cut by applying a break force to the scribe line 7, a pulse laser of an ultraviolet range is used as the pulse laser 2, and the pulse laser 2 is irradiated while the pulse laser 2 is being relatively moved so that the total number of pulses at each irradiation portion is in a range of 2,667 to 8,000 pulses, whereby the scribe line 7 is formed to a depth of 1.8 to 6.3% of the thickness of the glass 4.

### TECHNICAL FIELD

The present invention relates to a glass cutting method and an apparatus therefor, and more specifically, to a glass cutting method using pulse laser light of an ultraviolet range and an apparatus therefor.

### BACKGROUND ART

As a conventional, typical glass cutting method, as shown in FIG. 11, the following is known: a scribe line (notch line) 62 is formed on a front surface of glass 60 with a blade 61 such as a diamond blade or a super-hard blade, and thereafter, a break force (shock separation force) 63 is applied from a rear surface thereof to cut the glass 60 along the scribe line 62.

A glass cutting method using a laser is also known.

A method disclosed in Patent Document 1 involves, as shown in FIG. 12, irradiating the glass 60 with an infrared laser 74 shaped in an oval shape and transmitted through the glass with relative ease, and the vicinity of a rear side of a laser-irradiated portion is cooled with a refrigerant 75 (aqueous coolant). More specifically, an initial crack is previously prepared manually in a portion at which the glass 60 is to be cut. Then, the laser 74 is irradiated from the portion and the vicinity of a rear side of the irradiated portion is being cooled with the refrigerant 75 in a liquid form (or gaseous form) while both of them are scanned on the glass 60. This allows the initial crack to develop in a desired cutting direction owing to the thermal distortion of the inside of the glass 60, and a blind crack to occur in a depth direction, whereby a scribe line 72 (marking line) is formed. After the scribe line 72 is formed, by applying a break force 73 from the rear surface of the glass 60 and applying a bending moment to the blind crack, the glass 60 is cut.

A method disclosed in Patent Document 2 utilizes an ultraviolet laser with high photon energy in place of the infrared laser 74 shown in FIG. 12. One ultraviolet laser beam is condensed with a lens, and a molecular bond inside glass is directly broken, whereby a scribe line is formed without preparing an initial crack. Thus, the refrigerant 75 is not used. Note that, for breaking, an infrared laser is used instead of a mechanical shock. According to this method, a glass body is sublimated, and evaporated/scattered with an ultraviolet laser at a time of forming a scribe line. Therefore, dust and the like to be an obstacle in a post-process, such as shavings, are unlikely to be generated.

Patent Document 1 JP 09-150286 A

Patent Document 2 JP 05-32428 A

### DISCLOSURE OF THE INVENTION

### Problems to be Solved by the Invention

According to the cutting method using the blade 61 such as a diamond blade or a super-hard blade, there are disadvantages in that lateral cracks (cracks in a lateral direction) and micro-cracks occur during scribing to largely decrease the strength of glass, and particles and activated cullet are generated to adhere to the surface of glass strongly, which makes it necessary to perform a washing process. Further, the blade 61 is a consumable product, so that a cutting apparatus is stopped every time the blade 61 is exchanged.

In contrast, according to the cutting method using an infrared laser, although micro-cracks and particles can be relatively prevented from being caused at the cutting portion, an initial crack needs to be formed in a portion from which a scribe line extends. Therefore, the cutting operation is cumbersome, and for example, in the case of forming crossing scribe lines, if one scribe line is formed and then a scribe line crossing the previous scribe line is formed, it is difficult to draw the scribe line at a crossing point. Consequently, an initial crack needs to be formed at the crossing point again, which makes the operation remarkably cumbersome. Further, it is very difficult to select the strength of a laser and cooling conditions for making a scribe line from an initial crack.

On the other hand, in the case of using an ultraviolet laser as shown in Patent Document 2, it is desired that a relative movement is given to glass and a laser, and a needed scribe line is formed in a portion of glass to be cut by the irradiation of a laser in one stroke, in order to ensure the working efficiency and the satisfactory and uniform cut surface. However, in the case of forming a scribe line by irradiating a laser in one stroke, there is a technical problem in that the bending strength of glass after the glass is cut is about 50 MPa or less, and hence, the glass is likely to be subject to crack damage accidentally while the glass is being handled as liquid crystal panel glass or solar battery panel glass, for example.

The inventors of the present invention have studied on the enhancement of the strength of glass in the case of using an ultraviolet laser, and have found that the cause of the remarkable decrease in the strength of glass lies in an irregular state in which, when an ultraviolet laser is irradiated while glass is being moved in one direction in one stroke, re-molten glass adheres to the inside of a scribe groove, and sawtooth-shaped cracks occur in a bottom surface, whereby unevenness occurs in the scribe groove.

The inventors of the present invention have further found that the irregular state of the scribe groove is ascribable to the provision of unsuitable thermal energy. In particular, a conventionally used ultraviolet laser as shown in Patent Document 2 has a pulse width of at least several nanoseconds (n: 10-9), which is longer by about 10 times or more, compared with the relaxation time owing to the lattice vibration of excitors, which is about 100 picoseconds (p: 10-12) or less, so that the ratio of being converted to thermal energy is large. Consequently, the irregular state involving unevenness occurs in the scribe groove, and the bending strength of glass after cutting is only about 50 MPa or less.

### Means for Solving the Problems

The present invention has been achieved in order to solve the above-mentioned conventional technical problems, and the configuration thereof is as follows.

An invention according to claim 1 relates to a glass cutting method in which a portion to be cut of glass 4 is irradiated with a pulse laser 2 in one stroke of relative movement to form a scribe line 7, and then the glass is cut by applying a break force to the scribe line 7, characterized in that as the pulse laser 2, a pulse laser of an ultraviolet range is used, and that the scribe line 7 is formed to a depth in a range of 1.8 to 6.3% of a thickness of the glass 4 while the pulse laser 2 relatively so that a total number of pulses at each irradiation portion is in a range of 2,667 to 8,000 pulses.

In order to obtain the intended glass strength of 120 MPa or more while forming the scribe line 7 to a depth that corresponds to 1.8 to 6.3% of the thickness of the glass 4, the total number of irradiation pulses of the pulse laser 2 with respect to the same portion of the glass 4 is set to be at most 8,000 pulses, and the total of irradiation pulses is set to be at least 2,667 pulses.

An invention according to claim 2 relates to a glass cutting method according to claim 1, characterized in that a pulse width of the pulse laser 2 is less than 100 picoseconds.

An invention according to claim 3 relates to a glass cutting method according to claim 1 or 2, characterized in that the pulse laser 2 is a third harmonic, a fourth harmonic, or a fifth harmonic of an Nd:YAG laser, Nd:YVO4 laser, or Nd:YLF laser.

An invention according to claim 4 relates to a glass cutting method according to claim 1, 2, or 3, characterized in that a repetition frequency of the pulse laser 2 is 1 MHz or more.

An invention according to claim 5 relates to a glass cutting apparatus in which a portion to be cut of glass 4 is irradiated with a pulse laser 2 in one stroke of relative movement to form a scribe line 7, and then the glass is cut by applying a break force to the scribe line 7, the apparatus including a laser oscillation apparatus 1 for generating the pulse laser 2 of an ultraviolet range, and a moving stage 5 moving with the glass 4 placed thereon, characterized in that the scribe line 7 is formed to have a depth in a range of 1.8 to 6.3% of a thickness of the glass 4 by irradiating the pulse laser 2 while moving the moving stage 5 so that a total number of pulses at each irradiation portion is in a range of 2,667 to 8,000 pulses.

### Effect of the Invention

According to the invention as claimed in each of independent claims 1 and 5, in forming a scribe line by irradiating a portion of glass to be cut with a pulse laser, an ultraviolet pulse laser is used, the total number of pulses at each irradiation portion of glass is set in a range of 2,667 to 8,000 pulses, and the scribe line is formed to a depth corresponding to 1.8 to 6.3% of the thickness of the glass.

As a result, a scribe line with a predetermined depth is formed by irradiating an ultraviolet pulse laser with suitable thermal energy a number of times, whereby the adhesion of re-molten glass to the inside of a scribe groove and the occurrence of sawtooth-shaped cracks in a bottom surface can be suppressed satisfactorily. Further, a scribe line is formed by irradiating a pulse laser in one stroke of relative movement, so that the scribe line is formed rapidly and accurately. An ultraviolet laser has high photon energy, and directly breaks a molecular bond inside glass. Therefore, a scribe line can be formed efficiently without forming an initial crack. Consequently, the glass bending strength after cutting is remarkably enhanced, whereby it is possible to substantially eliminate the problem in that the glass is subjected to crack damage accidentally during a normal use as liquid crystal panel glass, solar battery panel glass, or the like. Specifically, the glass bending strength can be increased from about 50 MPa or less to 150 MPa or more (about 3 times or more).

### BRIEF DESCRIPTION OF THE DRAWINGS

FIG. 1 is a schematic diagram showing a cutting apparatus used for implementing a glass cutting method according to an embodiment of the present invention.

FIG. 2 is a cross-sectional view showing a cutting portion of glass according to an embodiment mode of the present invention.

FIG. 3 is a view illustrating an overlapping state of pulse laser beams according to an embodiment of the present invention.

FIG. 4 is a chart showing a moving stage speed—a scribe depth and the ratio of a scribe depth with respect to the thickness of glass according to an embodiment mode of the present invention.

FIG. 5 is a chart showing a moving stage speed, number of times of irradiation, irradiation energy, and irradiation energy density—glass bending strength characteristics according to an embodiment mode of the present invention.

FIG. 6 is a diagram schematically showing a microphotograph in the vicinity of a scribe line in a cross-section of glass cut along the scribe line by forming the scribe line with the speed of a moving stage being 80 mm/s and applying a break force according to an embodiment mode of the present invention.

FIG. 7 is a diagram schematically showing a microphotograph in the vicinity of a scribe line in a cross-section of glass cut along the scribe line by forming the scribe line with the speed of the moving stage being 160 mm/s and applying a break force according to an embodiment mode of the present invention.

FIG. 8 is a diagram schematically showing an microphotograph in the vicinity of a scribe line in a cross-section of glass cut along the scribe line by forming the scribe line with the speed of the moving stage being 240 mm/s and applying a break force according to an embodiment mode of the present invention.

FIG. 9 is an explanatory view illustrating a frequency f, a repetition period T, and a pulse width T of a picosecond laser and a nanosecond laser according to an embodiment mode of the present invention.

FIG. 10 is a view showing bending strength of glass cut with a picosecond laser and a nanosecond laser according to an embodiment mode of the present invention.

FIG. 11 is a perspective view showing a conventional cutting method.

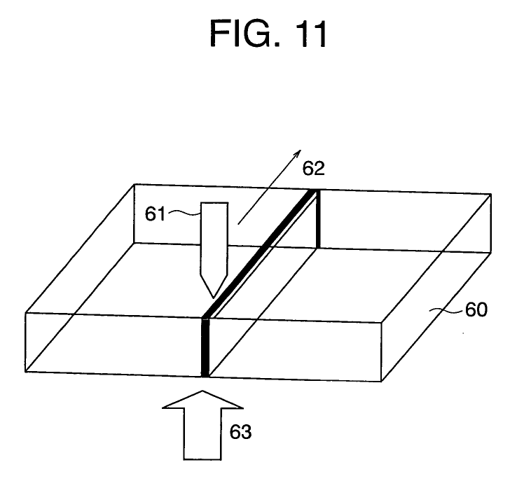

FIG. 12 is a perspective view showing another conventional cutting method.

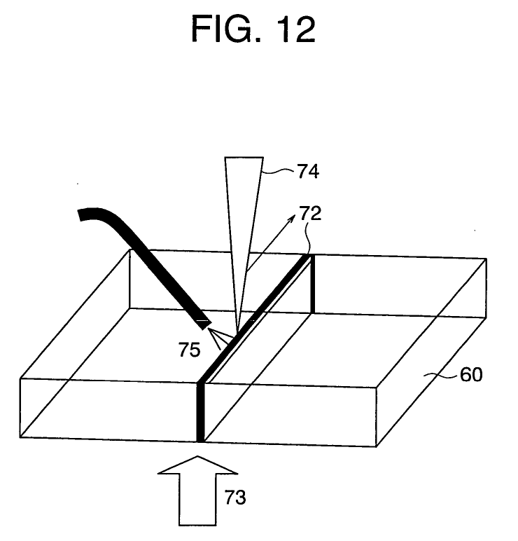

### BEST MODE FOR CARRYING OUT THE INVENTION

It is an object of the present invention to provide a glass cutting method and a glass cutting apparatus in which an ultraviolet pulse laser is used as a pulse laser, the pulse laser is irradiated while being relatively moved such that the total number of pulses at each irradiation portion is in a range of 2,667 to 8,000 pulses, and a scribe line 7 is formed to have a depth corresponding to 1.8 to 6.3% of a thickness of glass.

### Embodiment

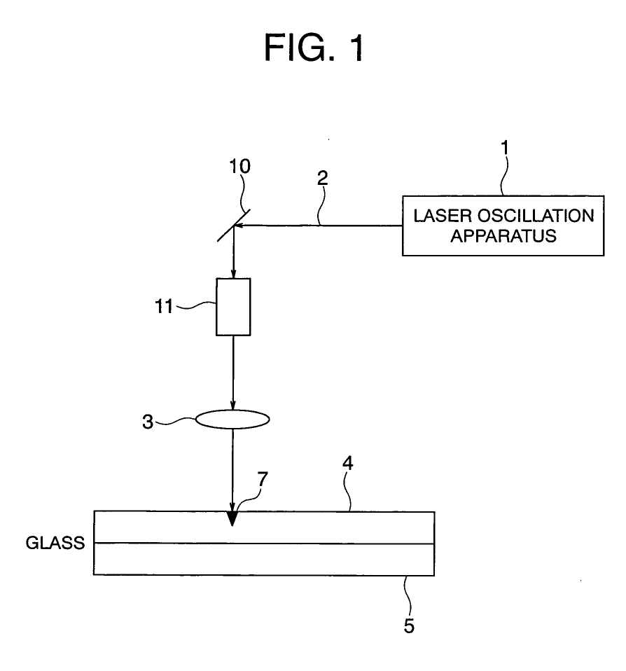

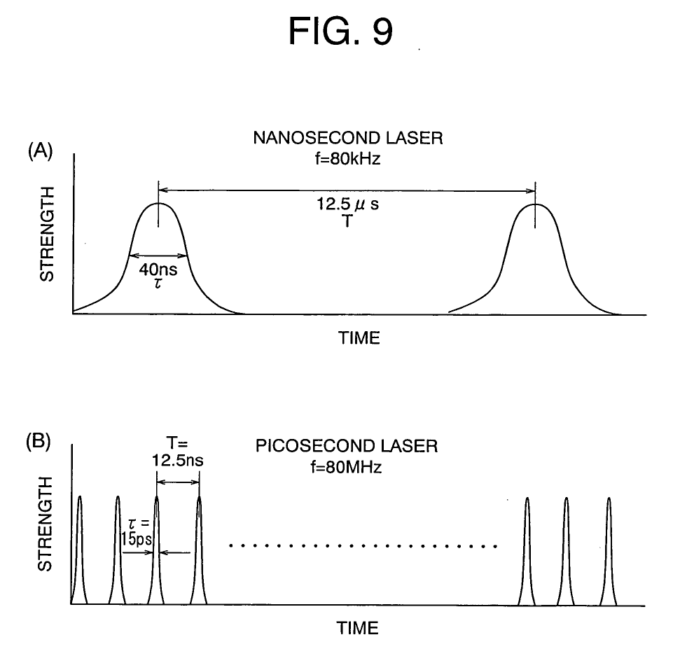

FIGS. 1 to 9 show an embodiment mode of a glass cutting apparatus according to the present invention. In FIG. 1, reference numeral 1 denotes a laser oscillation apparatus. The laser oscillation apparatus 1 emits a pulse laser 2 composed of an ultraviolet laser having a pulse width of less than 100 picoseconds (for example, τ=15 ps as shown in FIG. 9(B)). The repetition frequency of the pulse laser 2 is 10 MHz (10×106 Hz) or more (for example, f=80 MHz as shown in FIG. 9(B)). As the pulse laser 2 of an ultraviolet range, the third harmonic, the fourth harmonic, or the fifth harmonic of an Nd:YAG laser, Nd:YVO4 laser, or Nd:YLF laser can be used. Those ultraviolet lasers with a short wavelength have large energy of one photon, and can be photochemically decomposed. If irradiated for an appropriate time and number of times at an appropriate energy density, these lasers are capable of performing minute processing with precision having less thermal influence on the surroundings.

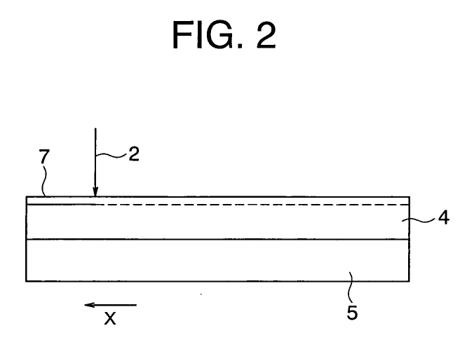

The pulse laser 2 emitted from the laser oscillation apparatus 1 changes its direction by 90° by a mirror 10, causes the beam to be enlarged in diameter by a beam expander 11 and be condensed by a condensing lens 3, and irradiates a linear portion to be cut of one side surface portion of flat glass 4. The glass 4 is placed on a moving stage 5, and the moving stage 5 relatively and continuously moves in a predetermined direction (direction perpendicular to the drawing surface of FIG. 1) at a predetermined speed with respect to the pulse laser 2. Actually, the moving stage 5 with the glass 4 placed thereon is driven by a driving apparatus (not shown), and linearly moves at a predetermined speed set in an X-direction of FIG. 2 with respect to the pulse laser 2. The energy profile of the pulse laser 2 may be a flat line-shaped beam. This type of pulse laser 2 can be formed by dividing and overlapping pulse lasers, shaping a pulse laser with a kaleidoscope, or shaping with a kinoform phase control plate.

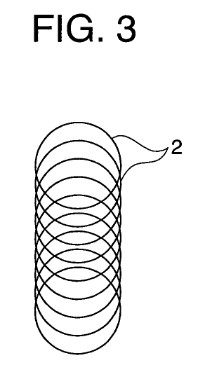

The pulse laser 2 performing a pulse operation is irradiated while the glass 4 on the moving stage 5 is being moved approximately in one stroke in a scribe direction X and the laser beams of the pulse laser 2 are appropriately overlapped. More specifically, the relative movement speed in the scribe direction X of the pulse laser 2 composed of circular beams shown in FIG. 3 is set such that the circular beams are overlapped at a predetermined interval by a predetermined number of times of overlapping (number of times of irradiation). Thus, the scribe line 7 formed by the irradiation of the pulse laser 2 is given a required depth by one movement of the moving stage 5 with the glass 4 placed thereon in the X direction. The pulse laser 2 can also be used by being shaped in a linear beam, an oval beam, or the like instead of a circular beam. At this time, the longitudinal direction of the linear beam or the oval beam is matched with the scribe direction X. In any shape, the relative movement speed in the scribe direction X is set such that beams are overlapped at a predetermined interval by a predetermined number of times of overlapping.

According to the irradiation of the pulse laser 2 composed of a so-called picosecond laser having a pulse width of less than 100 picoseconds, the energy (J/Pulse) per one pulse is much smaller (by about 1/1000 times) compared with a so-called nanosecond laser (shown in FIG. 9(A)) of the same ultraviolet range. Therefore, the pulse laser 2 in an irradiated portion effectively contributes to the evapotranspiration of the glass 4, and the thermal diffusion to the glass 4 is less, which suppresses the melting of the glass 4 due to thermal influence.

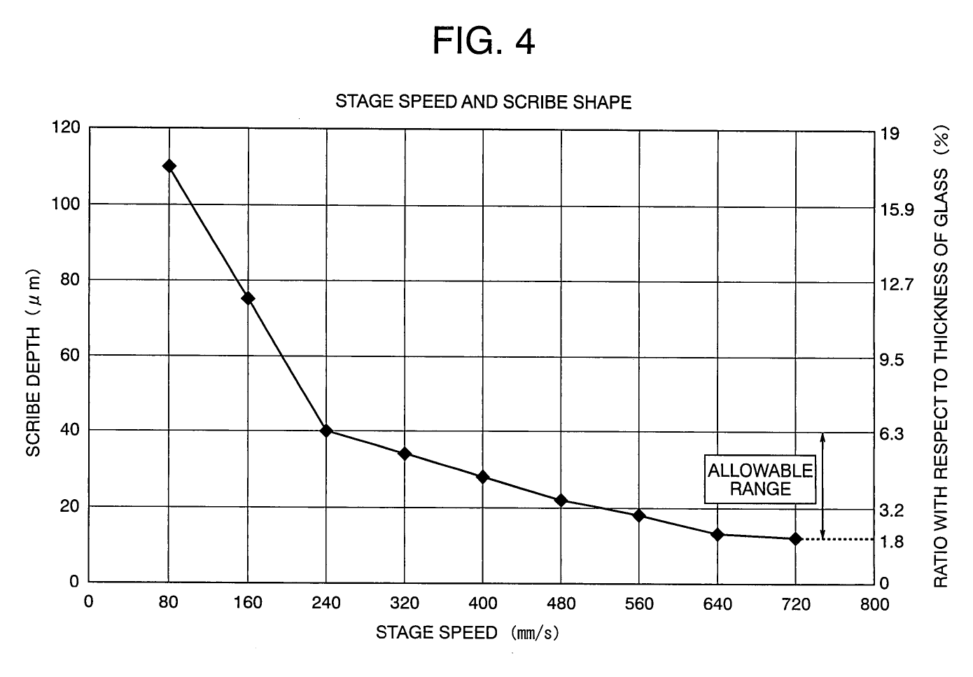

Here, the range of a scribe depth to be provided to the glass 4 will be described. When the depth of the scribe line 7 is too shallow, glass with an ordinary thickness cannot be cut satisfactorily by the action of a break force. Therefore, as shown in FIG. 4, as the thickness of the glass that can be broken, the lower limit of the ratio with respect to the thickness of the glass 4 is assumed to be 1.8%. On the other hand, the upper limit of the ratio of the depth of the scribe line 7 with respect to the thickness of the glass 4 is assumed to be 6.3%. This avoids the cause of a crack damage described later, and also avoids a useless scribe operation.

Using the glass cutting apparatus shown in FIG. 1, the pulse laser 2 (wavelength: 355 nm) was actually emitted from the laser oscillation apparatus 1 with an output of 8 W generating an Nd:YAG laser to form the scribe line 7 in the glass 4, and a break force was allowed to act on the glass 4, whereby the glass 4 was cut along the scribe line 7. As the break force, a mechanical shock force was used. As break means in a break process, conventionally known means can be adopted, and any of the mechanical shock, the cooling with a refrigerant made of liquid or gas, and the irradiation with an infrared laser may be used.

In forming the scribe line 7, the pulse laser 2 was condensed to a diameter of 24 μm by the condensing lens 3, and irradiated in a circular shape to one side surface portion of the glass 4. The pulse laser 2 has a pulse width τ of 15 ps, a repetition frequency f of 80 MHz, and a repetition period T of 12.5 ns, as shown in FIG. 9(B). On the other hand, the glass 4 with a thickness of 630 μm was used, and the scribe line 7 having a depth in a range of 1.8% (about 11 μm) to 6.3% (about 40 μm) with respect to the thickness of the glass 4 was formed. The apparatus shown in FIG. 1 does not apply a break force, so that it is a scribe apparatus in a glass cutting apparatus in a strict sense.

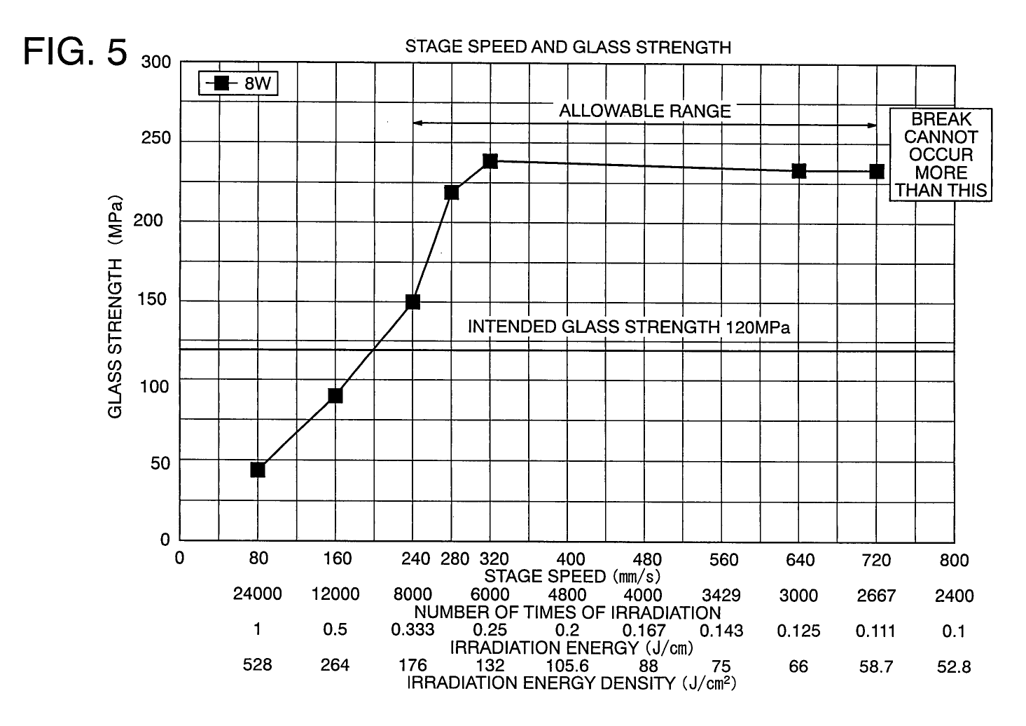

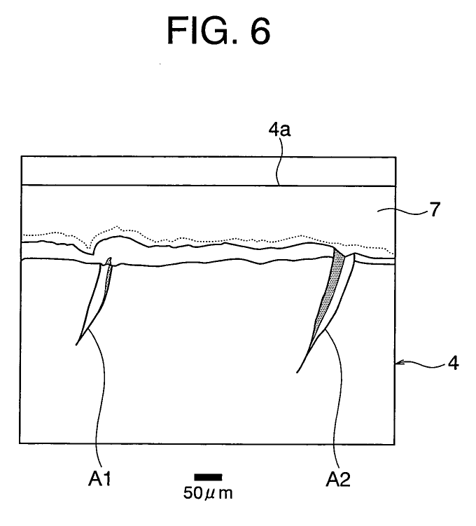

Further, the speed of the movement board 5 (stage) on which the glass 4 was placed was changed every 80 mm/s in a range of 80 to 720 mm/s. FIG. 5 shows the results, and FIGS. 6, 7, and 8 schematically show the microphotographs of cross-sections cut along the scribe line 7 by the application of a break force.

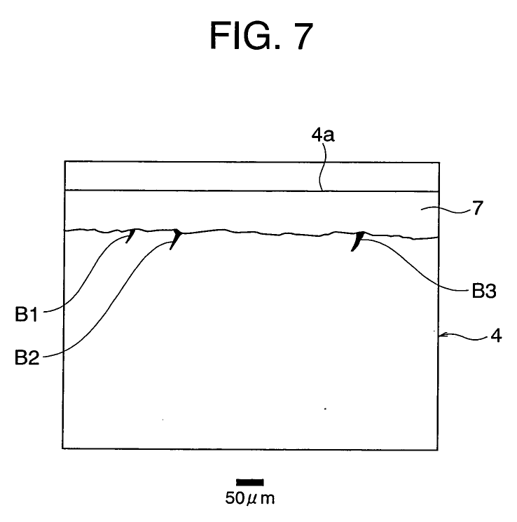

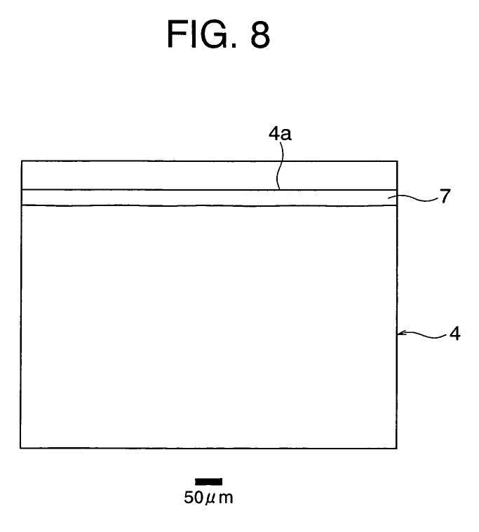

At the speed of the moving stage 5 of 80 mm/s, large cracks A1, A2 extending from the scribe line 7 formed on the surface 4a of the glass 4 to the inside in the thickness direction of the glass 4 developed, as shown in FIG. 6. At the speed of the moving stage 5 of 160 mm/s, small cracks B1, B2, B3 extending to the same direction developed, as shown in FIG. 7. However, at the speed of the moving stage 5 of 240 mm/s or more, cracks were not actually recognized in the periphery of the scribe line 7 formed on the surface 4a of the glass 4, substantially shown in FIG. 8. It is understood from FIG. 6 that, at the speed of the moving stage 5 of 80 mm/s, cracks A1, A2 developed from the scribe line 7 with a depth of about 110 μm in the depth direction of about 200 μm. The cracks A1, A2, B1, B2, B3 cause the damage of the glass 4 after cutting.

On the other hand, when the scribe line 7 with a depth of 1.8% was given by the irradiation of the pulse laser 2 to the glass 4 in one stroke, the speed of the moving stage 5 was 720 mm/s as shown in FIG. 4. When the scribe line 7 with a depth of 6.3% was given, the speed of the moving stage 5 was 240 mms as shown in FIG. 4. The upper limit of 6.3% (speed of the moving stage 5: 240 mm/s) of the ratio of the depth of the scribe line 7 with respect to the thickness of the glass 4 is important for avoiding an unnecessary scribe operation as described above, and it is also important for avoiding the remarkable decrease in the bending strength of the glass 4 as shown in FIG. 5.

As the cause of the remarkable decrease in the bending strength of the glass 4, the adhesion of re-molten glass to the scribe groove, as well as the development of the cracks A1, A2, B1, B2, B3 extending from the bottom surface of the scribe line 7 to the inside of the glass 4 were confirmed as a result of the experiment. When the number of irradiation pulses of the pulse laser 2 to the same portion of the glass 4 exceeds a predetermined number of times (8,000 pulses), the intended glass strength of 120 MPa cannot be ensured, which causes an accidental crack damage.

When the speed of the moving stage 5 was varied in a range of 240 to 720 mm/s so as to give the scribe line 7 with a depth of 1.8% to 6.3% by the irradiation of the pulse laser 2 in one relative stroke, and the number of pulses of the pulse laser 2 irradiated to the same portion of the glass 4 on the moving stage 5 corresponding to such speed of 240 to 720 mm/s is obtained, the number of pulses is in a range of 2,667 to 8,000 as shown in FIG. 5. Similarly, the irradiation energy corresponding to the total number of pulses of the pulse laser 2 became 0.333 to 0.111 (J/cm), and the irradiation energy density (D=N (irradiation number)×e (energy density of one pulse)) became 176 to 58.7 (J/cm2). The irradiation energy is the energy irradiated per unit length of the scribe line 7, which is a value corresponding to the total number of pulses depending upon the laser output value and the speed of the moving stage 5, irrespective of the size of a beam diameter of the pulse laser 2 when the scribe line 7 with a width according to the beam diameter of the pulse laser 2 is formed.

The bending strength of the glass 4 after cutting by the action of a break force is desirably 120 MPa or more in general use as a glass substrate of liquid crystal panel glass, solar battery panel glass, or the like. As is understood from FIG. 5, if the irradiation pulse number of the pulse laser 2 is set in a range of 2,667 to 8,000 times, the cutting that results in the bending strength of 120 MPa or more can be performed. Thus, in order to ensure the intended glass strength of 120 MPa, the maximum total number of irradiation pulses of the pulse laser 2 to the same portion was set to be 8,000 pulses, and the minimum number of irradiation pulses was set to be 2,667 pulses so as to enable a break. FIG. 5 shows this as an allowable range.

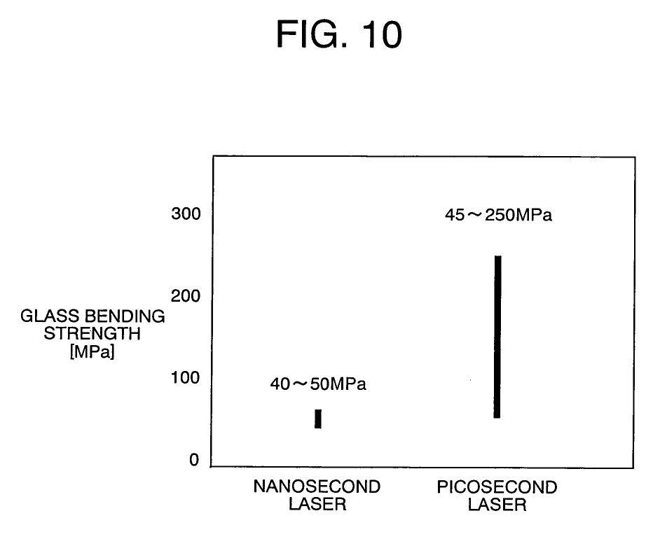

Thus, by irradiating the pulse laser 2 to the same portion of the glass 4 such that the pulse number is 2,667 to 8,000, and forming the scribe line 7 with a depth in a range of 1.8 to 6.3% of the thickness of the glass 4 (the allowable range shown in FIG. 4), the adhesion of re-molten glass to the groove of the scribe line 7, and the uneven irregular state where the sawtooth-shaped cracks A1, A2, B1, B2, B3 develop in the bottom surface can be satisfactorily prevented. If the speed of the moving stage 5 is set to be 280 mm/s instead of 240 mm/s the glass strength of about 220 MPa is obtained, so that the glass bending strength is enhanced by four times or more from the conventional strength of about 50 MPa or less. Although the glass bending strength (MPa) after cutting can be obtained in a range of 45 to 250 MPa in glass scribed with a so-called picosecond laser, as shown in FIG. 10, it is 40 to 50 MPa in glass scribed with a so-called nanosecond laser. Furthermore, the total number of pulses is about 3 to 12 pulses when a conventional laser with a pulse width of tens of nanoseconds is used, and a scribe line is formed to a depth of 1.8 to 6.3% of the thickness of the same glass 4.

### INDUSTRIAL APPLICABILITY

The present invention is applicable not only to a two-layered laminated glass, but also to laminated glass of two or more layers.

1. A glass cutting method in which a portion to be cut of glass (4) is irradiated with a pulse laser (2) in one stroke of relative movement to form a scribe line (7), and then the glass is cut by applying a break force to the scribe line (7),
wherein as the pulse laser (2), a pulse laser of an ultraviolet range is used, and that the scribe line (7) is formed to a depth in a range of 1.8 to 6.3% of a thickness of the glass (4) by irradiating the pulse laser (2) while moving the pulse laser (2) relatively so that a total number of pulses at each irradiation portion is in a range of 2,667 to 8,000 pulses.

2. A glass cutting method according to claim 1, wherein a pulse width of the pulse laser (2) is less than 100 picoseconds.

3. A glass cutting method according to claim claim 1, wherein the pulse laser (2) is a third harmonic, a fourth harmonic, or a fifth harmonic of an Nd:YAG laser, Nd:YVO4 laser, or Nd:YLF laser.

4. A glass cutting method according to claim claim 1, wherein a repetition frequency of the pulse laser (2) is 1 MHz or more.

5. A glass cutting apparatus in which a portion to be cut of glass (4) is irradiated with a pulse laser (2) in one stroke of relative movement to form a scribe line (7), and then the glass is cut by applying a break force to the scribe line (7), the apparatus comprising a laser oscillation apparatus (1) for generating the pulse laser (2) of an ultraviolet range, and a moving stage (5) moving with the glass (4) placed thereon,
wherein the scribe line (7) is formed to have a depth in a range of 1.8 to 6.3% of a thickness of the glass (4) by irradiating the pulse laser (2) while moving the moving stage (5) so that a total number of pulses at each irradiation portion is in a range of 2,667 to 8,000 pulses.

6. A glass cutting method according to claim 2, wherein the pulse laser (2) is a third harmonic, a fourth harmonic, or a fifth harmonic of an Nd:YAG laser, Nd:YVO4 laser, or Nd:YLF laser.

7. A glass cutting method according to claim 2, wherein a repetition frequency of the pulse laser (2) is 1 MHz or more.

8. A glass cutting method according to claim 3, wherein a repetition frequency of the pulse laser (2) is 1 MHz or more.
